(19) United States
(12) Patent Application Publication
(10) Pub. No.: US 2013/0087935 A1
(43) Pub. Date: Apr. 11, 2013

(54) CARBURETOR SHUT-OFF VALVE

(71) Applicant: WALBRO ENGINE MANAGEMENT, L.L.C., Tucson, AZ (US)

(72) Inventor: Scott D. Bostian, Kingston, MI (US)

(73) Assignee: WALBRO ENGINE MANAGEMENT, L.L.C., Tucson, AZ (US)

(21) Appl. No.: 13/623,943

(22) Filed: Sep. 21, 2012

Related U.S. Application Data
(60) Provisional application No. 61/545,378, filed on Oct. 10, 2011.

(51) Int. Cl. F02M 9/12; F02M 37/04

(52) U.S. Cl. 261/34.2; 261/38

(57) ABSTRACT

In at least some implementations, a valve for a carburetor that is moveable between open and closed positions includes a first valve portion adapted to at least substantially inhibit a first fluid flow in the carburetor when the valve is closed and a second valve portion associated with the first valve portion to at least substantially inhibit a second fluid flow in the carburetor when the valve is closed. In this way, two fluid flows may be at least substantially inhibited at the same time by the valve. In some forms, the fluid flows may include a primary fluid flow to an engine and a secondary fluid flow, such as from an accelerator pump, to the engine.

### REFERENCE TO CO-PENDING APPLICATION

This application claims the benefit of U.S. Provisional Application No. 61/545,378 filed Oct. 10, 2011, which is incorporated herein by reference in its entirety.

### TECHNICAL FIELD

The present disclosure relates generally to a carburetor and more particularly to a carburetor with a shut-off valve.

### BACKGROUND

Carburetors are used to supply a fuel and air mixture to an internal combustion engine. Some carburetors provide a main fuel supply to an engine and also an auxiliary supply such as from an accelerator pump, to support engine operation under certain operating conditions when the engine may need additional fuel for steady operation.

### SUMMARY

In at least some implementations, a valve for a carburetor that is moveable between open and closed positions includes a first valve portion adapted to at least substantially inhibit a first fluid flow in the carburetor when the valve is closed and a second valve portion associated with the first valve portion to at least substantially inhibit a second fluid flow in the carburetor when the valve is closed. In this way, two fluid flows may be at least substantially inhibited at the same time by the valve. In some forms, the fluid flows may include a primary fluid flow to an engine and a secondary fluid flow, such as from an accelerator pump, to the engine.

In at least some implementations, a carburetor includes a fuel supply, a fuel circuit through which fuel from the fuel supply is routed to an engine, an accelerator pump through which fuel is selectively discharged through the carburetor to the engine to support engine acceleration, and a valve. The valve has a first valve portion adapted to, when the valve is closed, inhibit or prevent fuel flow from the fuel supply to the engine and a second valve portion adapted to inhibit or prevent fuel flow from the accelerator pump to the engine. In at least some forms, the valve may be driven by a solenoid and the first and second valve portions may be defined on an armature of the solenoid.

### BRIEF DESCRIPTION OF THE DRAWINGS

The following detailed description of preferred embodiments and best mode will be set forth with reference to the accompanying drawings, in which:

FIG. 1 is a side view of a portion of a carburetor having an accelerator pump and a shut-off valve;

FIG. 2 is a bottom view of the carburetor portion shown in FIG. 1;

FIG. 3 is a side view of the carburetor portion shown in FIG. 1;

FIG. 4 is a fragmentary sectional view showing the accelerator pump;

FIG. 5 is a sectional view showing a float bowl of the carburetor and the shut-off valve in a first position;

FIG. 6 is sectional view like FIG. 5 and showing the shut-off valve in a second position;

FIG. 7 is a perspective view of the shut-off valve; and

FIG. 8 is a fragmentary sectional view showing a supplemental passage leading to a main carburetor bore.

### DETAILED DESCRIPTION OF PREFERRED EMBODIMENTS

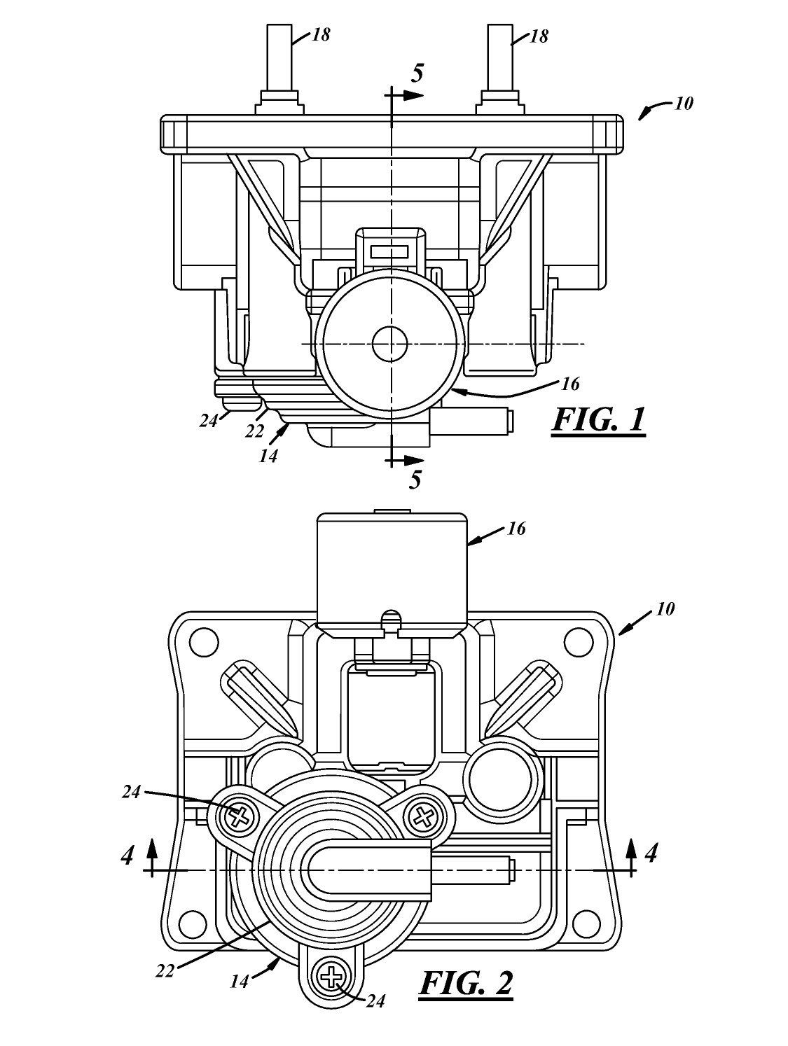

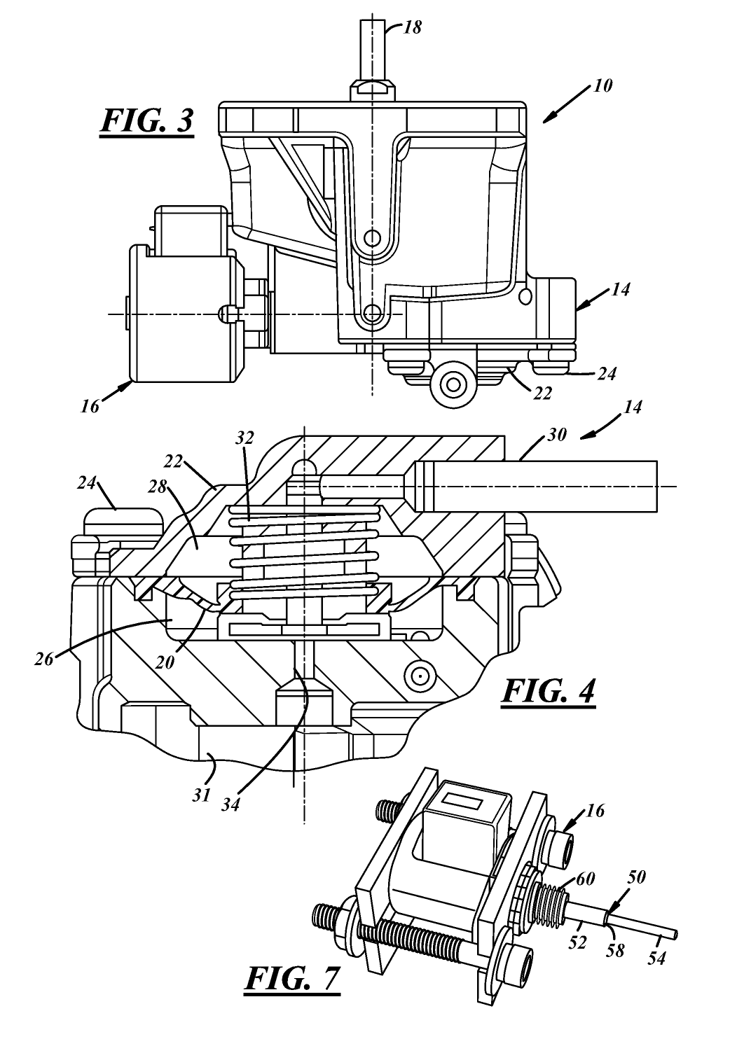

Referring in more detail to the drawings, FIGS. 1-3 illustrate a float bowl 10 of a carburetor having an accelerator pump 14 and a shut-off valve 16. The carburetor shown has two fuel supply pipes 18 through which fuel is supplied into two bores of the carburetor (a so-called dual bore carburetor). In the carburetor bores, air is mixed with the fuel and the fuel and air mixture is delivered to the engine to support engine operation. A single bore carburetor could also be used. The accelerator pump 14 provides additional fuel to the carburetor bores and may do so through a flow path that is separate from the fuel supply pipes (as is shown in the drawings) or a flow path that provides fuel into one or both fuel supply pipes 18 to support engine acceleration. The shut-off valve 16 isolates the accelerator pump 14 from the carburetor bores to prevent the supply of extra fuel from the carburetor to the engine. In the example shown, the accelerator pump 14 includes a diaphragm 20 (FIG. 4) that is referenced to the engine intake manifold. Therefore, upon engine shut down, the accelerator pump 14 may tend to provide extra fuel through the carburetor. This may cause an unintended combustion event in the engine, sometimes called a back fire or after boom. To inhibit or prevent this, the shut-off valve 16 may be closed to inhibit or prevent fuel flow from the accelerator pump 14 to the downstream carburetor bores.

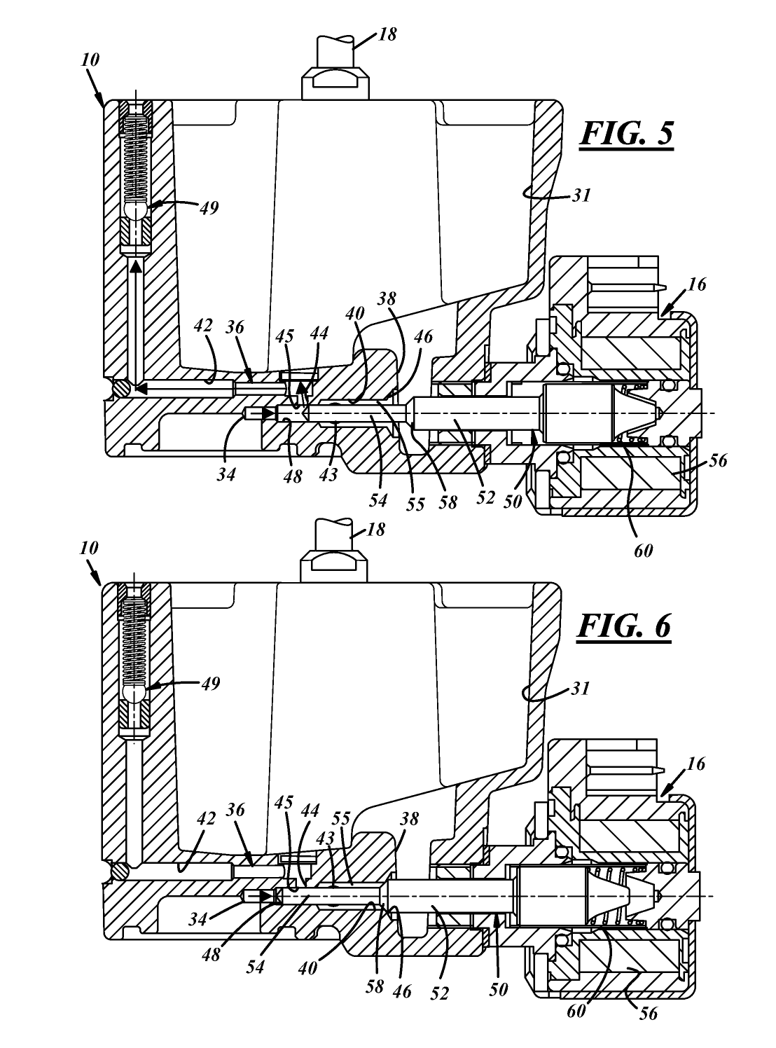

As shown in FIG. 4, the accelerator pump 14 includes a body 22 coupled to the float bowl 10, such as by screws 24. The body 22 and float bowl 10 define an interior volume that is divided into two chambers 26, 28 by the diaphragm 20. The first chamber 26 is a fuel supply chamber that is defined between the diaphragm 20 and the float bowl body 10. The second chamber 28 is a reference chamber defined between the diaphragm 20 and the body 22, and this chamber is communicated with the engine intake manifold via a conduit (not shown) connected to an inlet 30. As best shown in FIGS. 5 and 6, the fuel supply chamber 26 communicates with a fuel chamber 31 of the float bowl 10 to receive fuel therein and the diaphragm 20 is driven by a pressure differential across it to move against the force of a spring 32 and discharge an extra amount of fuel through an outlet 34 of the fuel supply chamber 26. The outlet 34 leads to a supplemental fuel flow path through which fuel discharged from the accelerator pump 14 flows to the main carburetor bore(s) for delivery to the engine during at least certain engine operating conditions. The supplemental fuel flow path may be open to and considered part of a main fuel supply circuit through which fuel is supplied to the main carburetor bore(s).

The main fuel supply circuit 36 includes an outlet 38 from the float bowl chamber 31, a first passage 40, a second passage 42 and a connecting passage 44. The first passage 40 leads from the float bowl chamber 31 to main fuel outlet 43 which leads to the fuel supply pipes 18 to provide a primary fuel supply to the main carburetor bore(s). A valve seat 46 may be provided in the first passage 40. The valve seat 46 may be an annular radially extending or radially tapered shoulder through which the first passage 40 extends. The first passage 40 may include a reduced diameter portion 48 that communicates with the outlet 34 of the fuel supply chamber 26. Fuel discharged from the accelerator pump 34 enters the portion 48 of the first passage 40 at least when the valve 16 is open. The portion 48 of the first passage 40 leads to the connecting passage 44.

The connecting passage 44 includes an opening 45 at the intersection with the first passage 40. The connecting passage 44 need not be of any significant length such that the connecting passage 44 may be defined primarily, in at least some implementations, by the opening 45. The opening 45 is radially spaced from an axis of the first passage 40, and as shown, is formed in a wall defining the first passage 40. The second passage 42 extends from the connecting passage 44 and leads to one or more of the main carburetor bores through a supplemental passage 47 (FIG. 8) and may include one or more nozzles or jets to control the flow rate of fuel therethrough, and a check valve 49 that is normally closed except when opened by a flow of fuel from the accelerator pump 14.

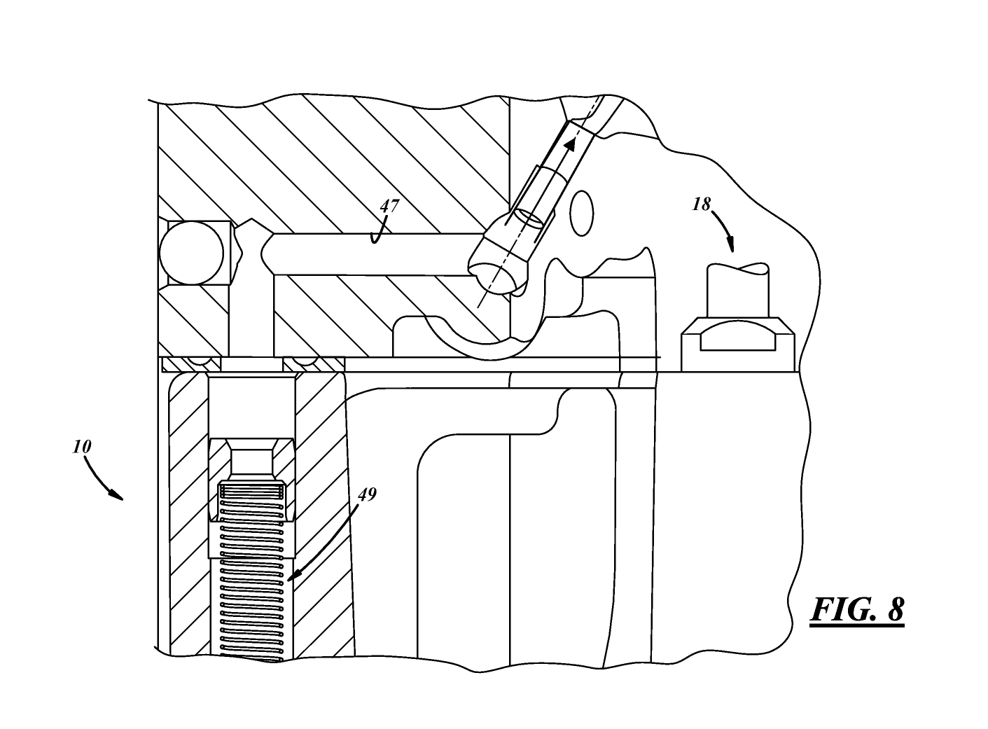

As best shown in FIGS. 5-7, the shut-off valve 16 may be a solenoid valve. The valve 16 may include an armature 50 driven between advanced and retracted positions. The armature 50 may include a first valve portion 52 and a second valve portion 54. The first valve portion 52 may be defined by a first, larger diameter portion of the armature 50 adapted to engage the valve seat 46 to inhibit or prevent fuel flow from the float bowl chamber 31 through the valve seat 46. The second valve portion 54 may be defined by a second, reduced diameter portion of the armature 50 located outboard of the first valve portion 52 (relative to a coil 56 of the solenoid) and formed as a second feature of the same component, formed from the same piece of material, or formed from a different material and carried by or otherwise moved with the first valve portion 52. In the implementation shown, the first and second valve portions 52, 54 are coaxially arranged, although it is not necessary. A beveled shoulder or transition portion 58 may be defined between the first valve portion 52 and the second valve portion 54. The transition portion 58 may engage the valve seat 46 when the armature 50 is extended which defines the closed position of the valve 16. The second valve portion 54 may extend through the valve seat 46 with a gap 55 defined therebetween to permit fluid flow through the valve seat 46, around the second valve portion 54 and through the main fuel outlet 43 when the valve 16 is open.

The second valve portion 54 may be sized for a relatively close fit in the portion 48 of the first passage 40 adjacent to the connecting passage 44. This isolates the accelerator pump 14 and the second passage from the main fuel outlet 43 such that fuel discharged from the accelerator pump does not flow to the main fuel outlet 43, at least not in any significant amount. Instead, the output from the accelerator pump 14 flows through the connecting passage 44 and into the second passage when the armature 50 is retracted and the valve is in its open position, as shown in FIG. 5.

When the armature 50 is extended, as shown in FIG. 6, the second valve portion 54 may extend beyond the intersection of the connecting passage 44 with the first passage 40 (e.g. opening 45) so that the outer surface of the second valve portion 54 at least substantially inhibits or prevents fuel flow from the first passage 40 into the connecting passage 44 when the shut-off valve 16 is in its closed position. So constructed and arranged, and in at least some implementations, the armature 50 may be driven axially between its open and closed positions and it may axially engage a valve seat to at least substantially inhibit a first fluid flow (such as to the main fuel outlet 43) and may be radially aligned with a second passage to at least substantially inhibit a second fluid flow through the second passage (such as from the accelerator pump 14 to the supplemental passage 47).

In use, when the pressure signal in the second chamber 28 and from the engine intake manifold drops sufficiently, the accelerator pump 14 provides extra fuel through the carburetor 12 through the first fuel passage 40 (e.g. portion 48), connecting passage 44, second fuel passage 42 and supplemental passage 47). The engine intake manifold pressure may drop sufficiently under rapid acceleration of the engine. In this case, the extra fuel supply supports the engine acceleration whereas without the extra fuel supply the fuel and air mixture delivered from the carburetor 12 to the engine might be too lean resulting in poor engine acceleration response. The engine intake manifold pressure also drops when the engine is shut down. In this case, extra fuel supply to the engine from the accelerator pump 14 is not desired as supplying fuel to the engine does not promote engine shut down.

Accordingly, to inhibit or prevent the accelerator pump 14 from providing extra fuel to the engine at engine shut down, the shut-off valve 16 can be configured such that the armature 50 is extended (as shown in FIG. 6) before or as the engine is shut down. With the armature 50 extended, the second valve portion 54 extends past the opening 45 of the connecting passage 44 to close or substantially block flow through the connecting passage 44 so any fuel that might be pumped through the connecting passage 44 by the accelerator pump 14 is blocked by the second valve portion 54. At the same time, the first valve portion 52 inhibits or prevents fuel flow through the valve seat 46 so the fuel supply from the float bowl chamber 31 to the fuel supply pipes 18 is interrupted to prevent fuel flow to the engine through the main fuel supply circuit 36. Therefore, fuel supply to the engine from both the float bowl chamber 31 and the accelerator pump 14 is simultaneously prevented or at least substantially inhibited by the shut-off valve 16.

In the implementation shown, one valve portion closes off an axially oriented passage/valve seat and another valve portion closes off or substantially inhibits flow through a peripheral, radially oriented opening/passage. As used herein, the term “radially” includes more than simply an opening or a passage that extends in a true radial direction from the axis and also includes openings/passages that are inclined relative to a radius and inclined relative to the axis. Two axially oriented valve seats may be used, but tolerances in the carburetor body and the armature may make providing a sufficient axial seal at two locations difficult as the axial length of the passages and valve portions may vary over a production run of these parts. Although, a sufficient seal for any given application could be achieved this way.

To enable the shut-off valve 16 to close (i.e. extend the armature 50) when the engine is shut down, the armature 50 may be yieldably biased by a spring 60 toward its extended position (FIG. 6). When electrical power is not provided to the solenoid coil 56, the spring force will extend the armature 50 until the first valve portion 52 engages the valve seat 46. As shown in FIG. 5, when electrical power is provided to the solenoid coil 56, the force the solenoid provides on the armature 50 retracts the armature 50 to move the first valve portion 52 away from the valve seat 46 and permit fluid flow through the valve seat 46. When the armature 50 is retracted, the second valve portion 54 is also moved away from the connecting passage 44 to permit fluid flow from the accelerator pump 14 through the connecting passage 44 to provide the extra fuel desired to support engine acceleration. Accordingly, the same motion or actuation of the shut-off valve 16 closes off both fuel flow from the float bowl chamber 31 and the accelerator pump 14. This may be accomplished with two valve portions 52, 54 on the same valve body 50. The two valve portions 52, 54 may be formed from the same piece of material (as in the implementation shown in the drawings), from two separate pieces coupled together, or from two different valves that are dependently moved (i.e. one moves the other) or independently moved (i.e. two separate valves that are independently actuated).

In the implementation shown, the fuel flow from the accelerator pump 14 and the fuel flow from the float bowl chamber 31 both are present in different portions of the first fuel passage 40 and its reduced diameter portion 48, and in a straight, axially extending portion of the passage. In this implementation, the accelerator pump 14 communicates with a portion 48 of the first fuel passage 40 that is downstream of the valve seat 46 and the connecting passage 44 is located downstream of the valve seat 46. So a straight, laterally slidable valve body (armature 50) can inhibit or prevent both fuel flow paths as noted above, which can simplify shutting off both fuel flow paths (primary flow path to the fuel supply pipes 18 and supplemental flow path from the accelerator pump 14) at engine shut down to prevent a back fire. In the implementation shown, the float bowl chamber 31 flows into the first fuel passage 40 at a location that is on the opposite side of the connecting passage 44 as the area where the outlet 34 of the accelerator pump 14 flows into the first fuel passage 40. Of course, other arrangements could be utilized.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A valve for a carburetor that is moveable between open and closed positions, comprising:
a first valve portion adapted to at least substantially inhibit a first fluid flow in the carburetor when the valve is closed; and
a second valve portion associated with the first valve portion to at least substantially inhibit a second fluid flow in the carburetor when the valve is closed.

2. The valve of claim 1 where in the first valve portion and second valve portion are connected together.

3. The valve of claim 2 wherein the first valve portion and second valve portion are formed from the same piece of material.

4. The valve of claim 3 wherein the valve is a solenoid valve and the first valve portion and second valve portion are formed on an armature.

5. The valve of claim 2 wherein the first valve portion and second valve portion have an axis and are moved axially between open positions permitting fluid flow past the valve portions and closed positions at least substantially inhibiting the first and second fluid flows.

6. The valve of claim 5 wherein the first valve portion has a first outer diameter and the second valve portion has a second outer diameter that is smaller than the first outer diameter, and a shoulder is defined between the first and second valve portions with the shoulder adapted to engage a valve seat when the first valve portion is in its closed position to close off the first fluid flow.

7. The valve of claim 5 wherein the second valve portion is adapted to provide a radial seal to substantially inhibit the second fluid flow.

8. A carburetor, comprising:
a fuel supply;
a fuel circuit through which fuel from the fuel supply is routed to an engine;
an accelerator pump through which fuel is selectively discharged through the carburetor to the engine to support engine acceleration; and
a valve having a first valve portion adapted to, when the valve is closed, inhibit or prevent fuel flow from the fuel supply to the engine and a second valve portion adapted to inhibit or prevent fuel flow from the accelerator pump to the engine.

9. The carburetor of claim 8 wherein the fuel circuit includes a first passage and a second passage, and when the valve is closed the first valve portion at least substantially inhibits fluid flow through the first passage and the second valve portion at least substantially inhibits fluid flow through the second passage.

10. The carburetor of claim 9 which also includes an opening between the first passage and the second passage and wherein the second valve portion blocks the opening when the valve is closed.

11. The carburetor of claim 9 wherein the first valve portion is axially moveable in the first passage and axially engageable with a seat to at least substantially inhibit fluid flow through the seat.

12. The carburetor of claim 10 wherein the opening is radially spaced from an axis of the first passage and an outer surface of the second valve portion is positioned adjacent to the opening when the valve is closed to at least substantially inhibit fluid flow through the opening.

13. The carburetor of claim 12 wherein the at least a portion of the valve is axially moveable in the first passage and axially engageable with a seat to at least substantially inhibit fluid flow through the seat, and when the valve is engaged with the seat, the second valve portion at least substantially inhibits fluid flow through the opening so that fluid flow through the opening and the seat are simultaneously at least substantially inhibited.

14. The carburetor of claim 8 wherein the first valve portion and second valve portion are connected together.

15. The carburetor of claim 14 wherein the first valve portion and second valve portion are portions of the same piece of material.

16. The carburetor of claim 11 wherein the first portion of the valve has a larger diameter than the second portion of the valve and a transition portion between them is adapted to engage the valve seat.

17. The carburetor of claim 16 wherein the second valve portion extends through the valve seat at least when the valve is closed.

18. The carburetor of claim 17 wherein a gap is provided between the second valve portion and the valve seat to permit fluid flow between them when the valve is open.
